(19) United States
(12) Patent Application Publication
(10) Pub. No.: US 2018/0325319 A1
(43) Pub. Date: Nov. 15, 2018

(54) BEVERAGE BOTTLE

(71) Applicant: OWW Our Wonderful World UG, Oberursel (DE)

(72) Inventor: Kim SOO HEE, Oberursel (DE)

(21) Appl. No.: 15/776,673

(22) PCT Filed: Sep. 27, 2016
(86) PCT No.: PCT/EP2016/072985

§ 371 Date: May 16, 2018

(30) Foreign Application Priority Data
Nov. 16, 2015 (DE) 10 2015 119 798.7

(51) Int. Cl. A47J 41/02; A47J 41/00; A47G 19/22

(52) U.S. Cl. CPC A47J 41/024; A47G 19/2288; A47J 41/0077

(57) ABSTRACT

A beverage bottle (1, 1′) with a bottle body (2) to which a bottle neck (4) opens into a mouthpiece (6) with a pouring opening (8) is formed, and whose bottle body (2) is double-walled, so it is intended for use in automatic filling and on an industrial scale. For this purpose and according to the invention, the bottle body (2) including the neck (4) is double-walled, and comprises of an outer container wall (10) and included therein, spaced apart from the inner container wall (14), wherein both the outer container wall (10) and the inner container wall (14) are integral with the mouthpiece (6) welded or materially connected to the mouthpiece (6). The vent opening (20) is closed with a plug (21).

### FIELD OF INVENTION

The invention relates to a beverage bottle with a body, to which a mouthpiece with a pouring spout is formed, whereas the bottle structure is double-walled.

### BACKGROUND

Vessels or containers in double-walled construction, for example, as a jug for coffee of tea, have been known for many years. Such Isolating vessels or flasks usually have, in the space between the vessel walls a vacuum and or an insulating layer to keep the temperature of the liquid cool or warm. The preparation of the vacuum in this space between the inner and outer container, however, is relatively expensive, and in the event of a material breakage or occurring leaks, the vacuum cannot be maintained. Such insulating containers are thus relatively sensitive and are therefore primarily used as commodities in a private environment, such as a carafe or individual beverage bottle. Use on an industrial scale, especially for machine filling in beverage production, in contrast, in particular with regard to the risk of breakage, but also because of the cost, is not possible. Commonly, drinks are stored or bottled in conventional glass bottles which are single-walled or simple glass (bottles with one layer of glass).

U.S. Pat. No. 8,225,957 B1 describes a thermally insulating glass bottle in which an inner bottle body can be inserted into an outer body to form a gap in the manner of a multi-part design. At the actual bottle body to a circumferential collar is formed, which are placed on the upper edge of the outer body and can be suitably sealed for sealing purposes. However, this embodiment of the insulating glass bottle is also not suitable for use on an industrial scale and for machine filling.

### SUMMARY

The invention is therefore based on the objective to provide an insulating, double-walled beverage bottle of the type mentioned above, which is also suitable for machine filling and on an industrial scale and for re-use.

This objective is achieved by making the bottle body including the bottle neck in double-walled construction, which comprises of an outer container wall and included within this, and spaced apart from the inner container wall, whereas both the outer container wall and the inner container wall are made as integral part with the mouth piece or are connected to the mouthpiece.

These enabling embodiments of the invention are subject of these sub-claims.

The invention is based on the consideration that for usability of the beverage bottle on an industrial scale and suitability for machine filling in particular, a high strength and a suitable adaptation to automated filling operations is be provided. Therefore, taking into account the sensitivity of the bottle with regards to a vacuum between the container walls, the space between the container walls should be with air, an inert gas or other, low thermal conductivity materials such as insulating foam. In order to counteract the lower insulation effect and to enable the use as an insulating vessel with sufficient insulation, the gap between and inner and outer container wall should be extended as much as possible to the bottleneck and the bottle mouthpiece. In order to ensure the required mechanical load capacity of such a construction for industrial applications, the mouthpiece should be provided as a point of contact for mechanical forces and designed accordingly.

In particular, during the automated machine filling the mouthpiece is the suitable point of contact for the corresponding components, by which the handling of the bottle, such as transporting, lifting, rinsing, drying, filling, sealing, packaging and the like, takes place. To take this into account and to enable that the external forces on this contact point, are comparatively effective and resilient, the container walls connected to the mouth piece should be connected with a suitably chosen, particularly robust executed connection technology.

To achieve this, the entire structure of the mouth piece and the inner and outer container wall can be made in one piece from a single piece, for example by glass blowing. Alternatively, the components can also be prefabricated separately and then joined with each other, using a cohesive connection such as welding, gluing or melting.

The bottle is therefore a storage vessel or an insulating bottle with a double-walled structure. An inner transparent container holds the liquid. An outer transparent container encloses the inner container and forms an air or insulating layer, which provides an insulating function.

The material for the beverage bottle is preferably selected to be suitable to represent the intended shape and the double walled structure and to enable the industrial production and use, in particular in high quantities. Materials that may be suitable for this purpose are, for example, selected thermoplastics. However, the container walls and/or the mouthpiece are preferably made out of glass, preferably out of borosilicate glass. In further developments, a combination of container walls made of glass, in particular borosilicate glass may be combined with a mouthpiece made from thermoplastics. The mouth piece can also be made of plastics or metals and connected seamlessness to the glass container.

The bottle is designed, especially at the connection of the container walls with the mouth piece, to be stable and robust, in order to allow multiple filling and cleaning and therefore enable to use the bottle as a recyclable bottle. The double-walled vessel is, at the upper end, in the region of the bottleneck and/or the mouthpiece, shaped such that a permanent connection to the double-walled vessel is made possible and the dynamic forces that occur during filling and closing of the bottle are suitably absorbed. However, in order to additionally achieve an further increased mechanical load bearing ability, which may be desirable in particular with comparatively large internal volume as a result of the weight of the liquid contained therein, a support connection piece between the inner and outer container wall at the bottom or in the lower region of the container is provided, to allow forces to be absorbed and forwarded to the bottom of the bottle. For this purpose, the inner container wall is supported on the outer container wall via a support structure piece arranged in the bottom region. Through these support structure piece, the forces, acting on the bottle parts while filled the container and during transporting, lifting, rinsing, drying, filling, sealing and packaging, are passed on to the bottle structure.

Such a support structure may be provided, for example, by one or more support pieces or connecting elements, suitably extending between the inner and outer container walls, preferably of the same material as the container walls or out of flexible materials such as e.g. Silicone. Alternatively or additionally, the support structure can also be achieved by suitable shaping of the components, for example an inward-arching bottom of the outer container wall which is directly in contact with the inner container wall in the central region. An alternative support structure can be achieved by introducing insulating foam into the gap.

Advantageously, for including a closure, preferably a reusable closure, and the bottleneck and in particular the mouthpiece is suitably designed. As a closure of the bottle, a cork, a glass stopper, a clip-lock, a threaded screw cap or a crown cap is preferably provided. The spout of the bottle neck or mouthpiece is shaped in such a way that no drop formation occurs during the pouring out of the liquid, i.e. that no “tea pot effect” arises during pouring. This is made possible by shaping the overhanging edge or a sharp edge is formed at the bottle neck or mouthpiece.

In order to enable reliable production of the beverage bottle in large numbers, the outer container wall is preferably provided with a vent opening. When the components are subjected to thermal stress, for example during sintering of the glass elements, an air exchange between the outside and the intermediate space between the container walls can take place via this vent hole, so that no material stresses caused by overpressures arises. In at least one of the outer walls of the vessel is a pressure compensation opening provided, which is, post production, closed in an advantageous form, via a plug or by glue, so that penetration of water or contaminants into the space between the two containers, is prevented.

The insulating volume formed between the inner container wall and the outer container wall is preferably filled with air, an inert gas or with foam. The foam is introduced during production and, due to its low thermal insulation coefficients, forms an insulating layer between the containers. Preferably inert gases or transparent foams with low thermal insulation coefficients are used.

With regard to possible applications of the beverage bottle, the outer container wall is coloured in an advantageous embodiment and/or provided with circumferential frosting. This makes it possible to keep the incidence of light into the container particularly low, so that comparatively light-sensitive liquids such as wine, water or spirits can be kept in the bottle. In addition, the container walls are configured in this way to be suited as surface for information or labels, in a visually appealing design.

In an alternative or additional embodiment, the outer container wall is provided with one or more circumferential reinforcing torus. This can, on the one hand strengthen the mechanical integrity and stability of the system, and on the other hand, provide design and creative variations.

The advantages achieved by the invention are in particular, that a comparatively stable structure is made possible by the design and connection of the components with each other. The beverage bottle is thus an insulated container which can be used as a single or reusable container and which is suitable for commercial use and for cooling and keeping warm of liquids as well as on industrial scale and for large volume machine filling. The beverage bottle can therefore be used in the beverage industry for consumable liquids, such as wines, mineral water, water, beers, liquor, fruit juices, etc., or in the medical sector. The bottle prevents liquids from adjusting too quickly to the outside temperature, i.e. the bottle isolates the liquids from external conditions and therefore keeps the temperature longer. The vessel can also keep the light impact into the container low.

The bottle can be used as a reusable container, so that it can be used several times before it is returned into the recycling cycle, or it is used once as a disposable bottle and can be recycled after use in the recycling cycle or as a utensil similar to a jug or decanter which can be used continuous.

In addition, the bottle makes it possible to present the content or the liquid visually attractive and transparent to a purchaser by storing the liquid in an inner transparent container and thus providing an additional visualization and marketing effect.

An execution example of the invention is explained in more detail in form of a drawing below. In particular:

### BRIEF DESCRIPTION OF THE DRAWINGS

FIG. 1 is a beverage bottle in a side view, and

FIG. 2 is the beverage bottle according to FIG. 1 in longitudinal section. Identical parts are provided in both figures with the same reference numbers.

### DETAILED DESCRIPTION

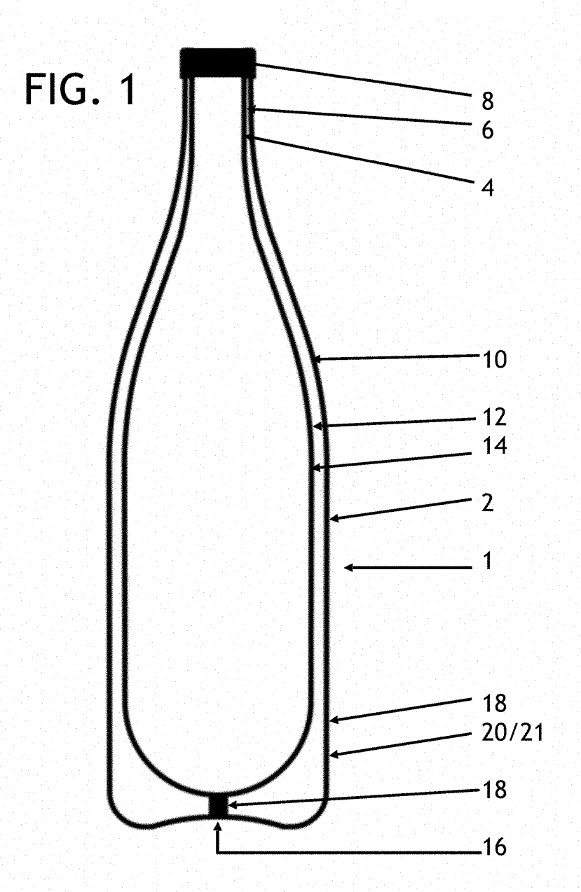

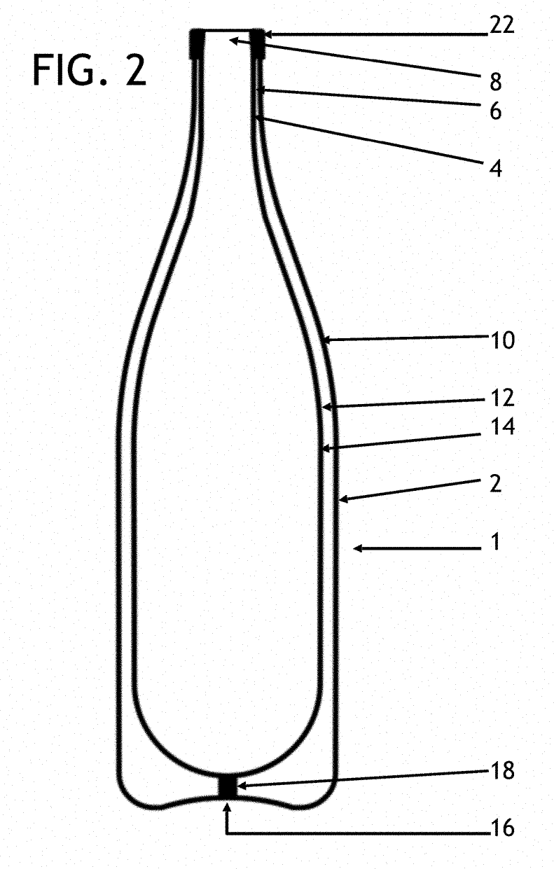

The beverage bottle 1 according to FIGS. 1 and 2 comprises a bottle body 2, to which a bottleneck 4 is connected. The bottleneck 4 connects into a mouthpiece 6, which is provided with a pouring opening 8 for the liquid stored in the beverage bottle 1. In the execution example, the beverage bottle 1 is designed in the shape of a wine bottle; Alternatively, the shape as a sparkling wine, mineral water, water, beer, liquor, vodka or fruit juice bottle or as a container for other liquids, in a format readily to sale, are possible.

The beverage bottle 1 is designed as a thermally insulating bottle, in which the liquid there-in is kept in an elevated or lowered temperature over an extended period of time. The beverage bottle 1 can therefore keep the liquid therein warm or cold. For this purpose, the bottle body 2 is double-walled and comprises an outer container wall 10, within which an inner container wall 14 is arranged to form a gap 12. The inner container wall 14 forms the actual vessel in which the respective liquid is held, and which is surrounded by the outer container which forms the outer shell 10 for protection purposes.

The beverage bottle 1 is especially designed to the extent for a possible use as a reusable and returnable bottle and/or for use in machine filling and on an industrial scale. In view of the required increased mechanical stability of the space 12—in contrast, for example, to a thermos or vacuum bottle—it is not provided with a vacuum, but with a comparatively poor thermal conductivity material, in the execution example it is filled with air. Alternatively, the gap 12 can also be filled with an inert gas which has a low thermal insulation coefficient, such as Xenon, or it can be filled with a foam, for example polyurethane foam. In order to ensure on the one hand, a high insulating effect for the liquid and on the other hand for the intended use, the necessary high mechanical stability and strength, the gap 12 is extended and extends beyond the bottleneck 4 up to the mouthpiece 6. The mouthpiece 6 is specifically provided as a point of contact for mechanical forces and designed accordingly.

To achieve the design goals, the double-walled configuration of the bottle body 2 extends up to and including the neck 4, so that the insulating gap 12 with the exception of the pouring piece 8 almost completely surrounds the interior of the beverage bottle 1, and to ensure increased mechanical stability, both the outer container wall 10 and the inner container wall 14 are each connected in one piece with the mouth piece 6 or bonded to the mouth piece 6.

In particular, with the comparatively large internal volume of the beverage bottle 1, transverse forces of considerable extent could occur as a result of the weight of the liquid therein, which could cause a risk of breakage at the connecting part of the inner container wall 14 with the mouth piece 6. To counteract this, a support connection piece 16 between the inner and outer container wall 10, 14 is provided at the bottom region of the beverage bottle 1, via which such forces can be transferred to the bottom of the bottle. In the execution example, a connection piece 18 is provided for forming a support structure, via which the inner container wall 14 is supported on the outer container wall 10. Alternatively or additionally, it is also possible to provide multiple support connections, and/or the floor of the outer container wall 10 can be curved or curved inwards in the central area, i.e., toward the inner container wall 14, and to be connected to it or connected in part with the bottom. Through these types of connection, the forces acting on the bottle parts when the containers are filled are transferred to the bottle structure.

In principle can the vessel be formed by the inner container wall 14 and the outer container wall 10 and could consist of a material which is preferably selected for industrial processing and mass production, for example plastics. In the execution example, is glass, in particular borosilicate glass, chosen as the base material for the inner and outer container walls 10, 14.

With regard to the preferred use of the beverage bottle 1 as a returnable and reusable bottle, the closure system for the vessel opening is designed for re-filling and re-closability. For this purpose, the mouth piece 6 at the pouring opening 8 is designed for mounting a reusable closure and is in particular designed such, that it can accommodate a cork, bottle caps or other reusable closures.

The inner vessel body is formed by the inner vessel wall 14 and is arranged at the outer vessel body formed by the outer vessel wall 10 in such a way, that a gas-filled space 12 is formed between the inner vessel body and the outer vessel body. In order to allow a reliable production while avoiding the risk of breakage due to thermal pressure fluctuations, the outer container wall 10 is provided with a vent opening 20. This hole is sealed with a plug 21 or otherwise, for example by means of a seal, and serves as a pressure equalization opening, which allows, in particular during assembly, a gas exchange for pressure equalization between the gap 12 of the two vessel bodies and the outer space. This pressure equalization hole is preferably closed after completion of the manufacturing process by a plug, glass material or adhesive to prevent moisture or contaminants from entering into the gap 12, which reduce the insulating ability. This pressure equalization opening is particularly important in the preferred intended use of glass as a base material to avoid stresses during manufacture and in particular during the fusion of the two vessel bodies.

In the execution example, the outer container wall 10 is coloured and frosted in a partial area. As a result, some light protection for the liquid can be provided to some extent, which improves the durability of the liquids especially for photosensitive liquids such as wine or the like. Furthermore, such a configuration is also particularly suitable for decorative purposes or for attaching information, for example in the form of labels, stickers or the like.

In FIG. 2, shows an alternative example of the beverage bottle 1′, the bottle body 2 is provided with an outer circumferential support 22 as reinforcement. This increases the mechanical stability of the vessel.

Such a glass bottle 1, 1′ is preferably produced by first providing the outer and the inner vessel body, wherein at least one of these vessel bodies has a wall with a pressure equalization hole. The inner vessel body is then placed in the outer vessel body and connected thereto. This is preferably done by fusing or welding together the inner and outer vessel bodies in at least one area, preferably in an upper edge area, of the two vessel bodies. This creates the air-filled gap 12 between the two vessel bodies. While the vessel bodies are connected to each other, the vent opening 20 allows a gas exchange between the gap 12 and the outside space, so that in the space 12 no excess or negative pressure can arise. This is necessary because, due to the high temperatures of several hundred degrees Celsius during melting, an overpressure would occur in the gap. After the vessel bodies have been joined together, the gap 12 can optionally be flushed through the vent hole 20 with a gas, for example air or an inert gas such as nitrogen or xenon, and therefore dried. Subsequently, the pressure equalization hole is closed by the plug, glass material, silicone or adhesive, to prevent water and contaminants enter into the space between the containers and to stop air or gas to escape.

### LIST OF REFERENCE NUMBERS

1 beverage bottle
2 bottle body
4 bottleneck
6 mouthpiece
8 pouring opening
10 outer container wall
12 gap
14 inner container wall
16 support piece
18 material connection piece
20 vent hole
21 plug or seal
22 reinforcement

1. A beverage bottle comprising a bottle body, and a bottle neck with an opening mouthpiece comprising an outpouring opening, wherein the bottle body and the bottle neck is comprise an outer container wall, spaced apart from an inner container wall within the outer container wall, wherein both the outer container wall and the inner container wall are connected with the mouth piece or are integrally connected to the mouth piece, wherein the inner container wall, outer container wall, or the mouth piece is made of glass, and wherein the inner container wall and the outer container wall form an insulating volume which is filled with air, an inert gas, or an insulating foam.

2. The beverage bottle of claim 1, wherein the inner container wall, outer container wall, or mouthpiece is made of borosilicate glass.

3. The beverage bottle of claim 1, wherein the inner container wall is supported by the outer container wall via a support structure piece arranged in a bottom region of the beverage bottle.

4. The beverage bottle of claim 1, wherein the opening mouthpiece is configured to accept a plurality of closure types to close the pouring opening.

5. The beverage bottle of claim 1, wherein the outer container wall comprises a vent hole.

6. The beverage bottle of claim 1, wherein the outer container wall or inner container wall is colored.

7. The beverage bottle of claim 1, wherein the outer container wall comprises a circumferential frosting.

8. The beverage bottle of claim 1, wherein the outer container wall comprises a circumferential reinforcement.
